(19) United States
(12) Patent Application Publication
(10) Pub. No.: US 2007/0071273 A1
(43) Pub. Date: Mar. 29, 2007

(54) Speaker

(76) Inventors: Hideo Kitazawa, Nagano (JP); Akinori Ushikoshi, Nagano (JP); Kenji Yokoyama, Tokyo (JP)

Correspondence Address: CANTOR COLBURN, LLP, 55 GRIFFIN ROAD SOUTH, BLOOMFIELD, CT, 06002, US

(21) Appl. No.: 11/529,655

(22) Filed: Sep. 28, 2006

(30) Foreign Application Priority Data
Sep. 28, 2005 (JP) 2005-282183

(51) Int. Cl. H04R 9/06

(52) U.S. Cl. 381/400; 381/396

(57) ABSTRACT

A speaker may include a center pole, a voice coil bobbin having a pipe body, and at least one or more electrodes which are disposed on the pipe body to detect an electrostatic capacity formed between the electrode and a side circumferential face of the center pole. The pipe body is comprised of a flexible board on which the electrode is formed. The flexible board may include a strip-shaped electric line drawing-out part which is formed with a film being extended from an edge portion of the pipe body, and the electric line drawing-out part is structured of the film on which an output line connected to a movable electrode and a grounded line connected to another electrode are printed.

### CROSS REFERENCE TO RELATED APPLICATION

The present invention claims priority under 35 U.S.C. §119 to Japanese Application No. 2005-282183 filed Sep. 28, 2005, which is incorporated herein by reference.

### FIELD OF THE INVENTION

An embodiment of the present invention may relate to a speaker. More specifically, an embodiment of the present invention may relate to a speaker which detects an electrostatic capacity formed between a voice coil bobbin and a center pole to control the operation of a diaphragm on the basis of the detection result.

### BACKGROUND OF THE INVENTION

In some audio speakers, a Motion Feed Back (MFB) circuit is included to improve the sound quality of the speaker. The MFB circuit detects the operating state of a diaphragm which vibrates through an electrical signal conveying audio information (hereinafter referred to as an “audio signal”) that is inputted into a speaker. The MFB circuit feedback-controls the diaphragm based on the detection result. In this manner, the distortion of sound, which is likely to occur especially in a low tone region, can be canceled. Therefore, it is often mistakenly assumed that the MFB circuit is effective to be utilized in a small-sized speaker in which reproduction in a low tone region is difficult.

For example, the following five references with regard to a MFB circuit are known: Japanese Patent Laid-Open No. Sho 52-79644, Japanese Patent Laid-Open No. Sho 53-12319, Japanese Patent Laid-Open No. Sho 53-12320, Japanese Patent Laid-Open No. Sho 53-12321, and Japanese Utility Model Laid-Open No. Sho 57-96589. In these references, the operating state of the diaphragm is detected by detecting the variation of an electrostatic capacity formed between electrodes. More specifically, an electrode (hereinafter, referred to as “movable electrode”) is fixed to a diaphragm, or to an electromagnetic coil which is referred to as a voice coil bobbin that causes the diaphragm to vibrate and another electrode (hereinafter, referred to as “fixed electrode”) is fixed so as to face the movable electrode. An electrostatic capacity, which varies with the movable electrode moving relative to the fixed electrode, is detected and outputted as a detection signal. A comparison device (for example, CPU) compares the detection signal with a predetermined reference value to control so as to amend the operation of the diaphragm on the basis of the comparison result.

When the movable electrode is provided in the voice coil bobbin to detect an electrostatic capacity, a shielding member for shutting off a disturbance noise and a plurality of electric conductor films (for example, copper film) that are used as the movable electrode are formed on an inner peripheral face or an outer peripheral face of the pipe body having an insulating property such as polyimide that is a base member of the voice coil bobbin. Further, one end of an output line for outputting the detected electrostatic capacity to the outside of the voice coil bobbin as an electrical signal is fixed to an electric conductor film which is the movable electrode with solder, and one end of a grounded line is fixed to an electric conductor film which is the shielding member with solder.

As described above, a plurality of electric conductor films is formed on the pipe body and electric lines such as the output line and the grounded line are connected to these electric conductor films. Therefore, the electric conductor films and the electric wires become a load that operates so as to prevent the operation of the voice coil bobbin and thus responsibility of the voice coil bobbin becomes worse. Further, in order to form an electric conductor film on the pipe body, a film comprising a nonmagnetic electric conductor such as copper is stuck on the inner peripheral face of the pipe body or copper is deposited on the inner peripheral face of the pipe body. However, these works require a lot of labor and thus the cost cannot be reduced.

### SUMMARY OF THE INVENTION

In view of the problems described above, an embodiment of the present invention may advantageously provide a speaker in which responsibility of a voice coil bobbin is enhanced. In addition, an embodiment of the present invention may advantageously provide a speaker in which a voice coil bobbin is easily produced.

Thus, according to an embodiment of the present invention, there may be provided a speaker including a center pole, a voice coil bobbin having a pipe body, and an electrode which is disposed on the pipe body for detecting an electrostatic capacity formed between the electrode and a side circumferential face of the center pole. In this speaker, the pipe body is comprised of a flexible board on which the electrode is formed. Therefore, since the weight of the pipe body can be considerably reduced, responsibility of the voice coil bobbin can be enhanced. Further, the pipe body may be produced by means of that a movable electrode is printed on a film which is comprised of polyimide or the like as a base member of a flexible board and then the film is formed in a cylindrical shape. Therefore, cost required to produce the voice coil bobbin can be considerably reduced.

In accordance with an embodiment, an output line is formed on a flexible board which is integrally formed with the pipe body for outputting an electrical signal corresponding to the electrostatic capacity detected with the electrode to an outer side of the pipe body. In this case, when the output line is printed on a strip-shaped flexible board which is drawn out from an edge portion of the pipe body, a load which is applied to the voice coil bobbin in a vibrating direction can be considerably reduced by flexibility of the flexible board. Further, when the output line is produced, the output line is only required to be printed on a film that is comprised of polyimide or the like as a base member of the flexible board and thus cost required to produce the voice coil bobbin can be considerably reduced.

In accordance with an embodiment, a grounded line which is connected to one of the electrodes is formed on the flexible board which is integrally formed with the pipe body. In this case, when the grounded line is printed on a strip-shaped flexible board that is drawn out from the pipe body, a load applied to the voice coil bobbin in a vibration direction can be considerably reduced by flexibility of the flexible board. Further, when the grounded line is formed, the grounded line is only required to be printed on a film that is comprised of polyimide or the like as a base member of the flexible board and thus cost required to produce the voice coil bobbin can be considerably reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view showing the structure of a speaker in accordance with an embodiment of the present invention.

FIG. 2 is a perspective view showing an appearance of a voice coil bobbin.

FIG. 3 is a cross-sectional view showing a part of a voice coil bobbin.

FIG. 4 is a functional block diagram showing an electrical structure of a speaker.

### DETAILED DESCRIPTION OF THE PREFERRED EMBODIMENTS

An example of a speaker will be described in detail below with reference to the accompanying drawings.

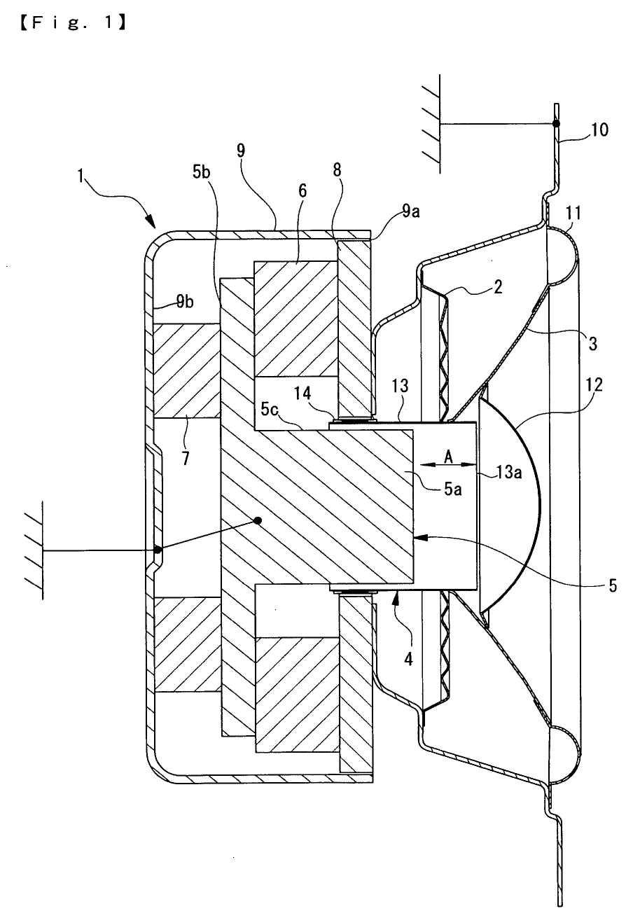

A speaker in accordance with an embodiment of the present invention is shown in FIGS. 1 through 4. A speaker 1 in accordance with an embodiment of the present invention is characterized in that a pipe body 13 for a voice coil bobbin 4 is structured with a flexible board 15 on which electrodes 25 are formed.

As shown in FIG. 1, the speaker 1 includes a damper 2, a diaphragm 3, a voice coil bobbin 4, a center pole 5, magnets 6 and 7, a circular ring shaped member 8, a case 9, a frame 10, a connection member 11, a center cap 12 and a box-shaped speaker box (not shown) that functions as a housing. The center pole 5, the magnets 6 and 7 and the circular ring shaped member 8 are accommodated in the case 9 which is formed in a bottomed cylindrical shape. They are fixed on an inner wall face of the case 9 with an adhesive, a screw or the like. The center pole 5 is made of iron and structured of a substantially cylindrical center pole main body 5a and a substantially disk-shaped flange 5b which is formed at a base end of the center pole main body 5a. The center pole 5 is disposed in the case 9 such that a tip end portion of the center pole main body 5a is protruded outside the case 9 from a substantially center portion of an aperture 9a of the case 9 and such that the axis of the center pole main body 5a coincides with the center of a bottom face 9b of the case 9. The center pole 5 and the case 9 are connected to the speaker box (not shown) and grounded.

The magnet 7 is formed in a substantially circular ring shape. The magnet 7 is disposed such that its center is located at the center of the bottom part 9b of the case 9 and fixed on the bottom part 9b with an adhesive. A bottom face of the flange 5b is fixed on a face on the aperture 9a side of the magnet 7 with an adhesive. The magnet 6 is formed in a substantially circular ring shape. The magnet 6 is disposed such that its center is located so as to correspond to the center of the bottom part 9b of the case 9 and fixed with an adhesive on a face of the flange 5b that faces the aperture 9a. The circular ring shaped member 8 which is made of iron is disposed such that its center coincides with the axis of the center pole main body 5a and is fixed with an adhesive on a face of the magnet 6 that faces the aperture 9a.

The voice coil bobbin 4 includes a substantially cylindrical pipe body 13 whose front end and rear end are opened and a coil 14. The diameter of the pipe body 13 is set to be slightly larger than the outer diameter of the center pole main body 5a, and the coil 14 which is structured of an electric conductor such as an enameled wire or a copper wire is wound around the outer peripheral face of the pipe body 13. The voice coil bobbin 4 structured as described above is inserted into a gap space between an inner peripheral face of the circular ring shaped member 8 and a side circumferential face 5c of the center pole main body 5a.

The frame 10 is fixed to the face on the aperture 9a side of the circular ring shaped member 8 with an adhesive. Another end of the frame 10 is fixed to an edge portion of an aperture which is formed in a front face plate of the speaker box (not shown) with an adhesive. An inner peripheral face of the damper 2 is fixed to an outer circumferential face of the pipe body 13 with an adhesive and an outer peripheral face of the damper 2 is fixed to an inner peripheral face of the frame 10 with an adhesive. In this manner, the voice coil bobbin 4 is held by the damper 2 in a space between the inner peripheral face of the circular ring shaped member 8 and the side circumferential face 5c of the center pole main body 5a. The diaphragm 3 functions as a so-called cone paper and its inner peripheral portion is fixed to the outer circumferential face of the pipe body 13 with an adhesive and its outer peripheral portion is connected with the frame 10 through the connection member 11. The center cap 12 comprises a main body portion formed in a dome shape and a flange portion formed along an outer peripheral edge of the main body portion, and the flange portion is fixed to the diaphragm 3 with an adhesive. In this manner, the aperture 13a on the front end side of the pipe body 13 is covered by the center cap 12.

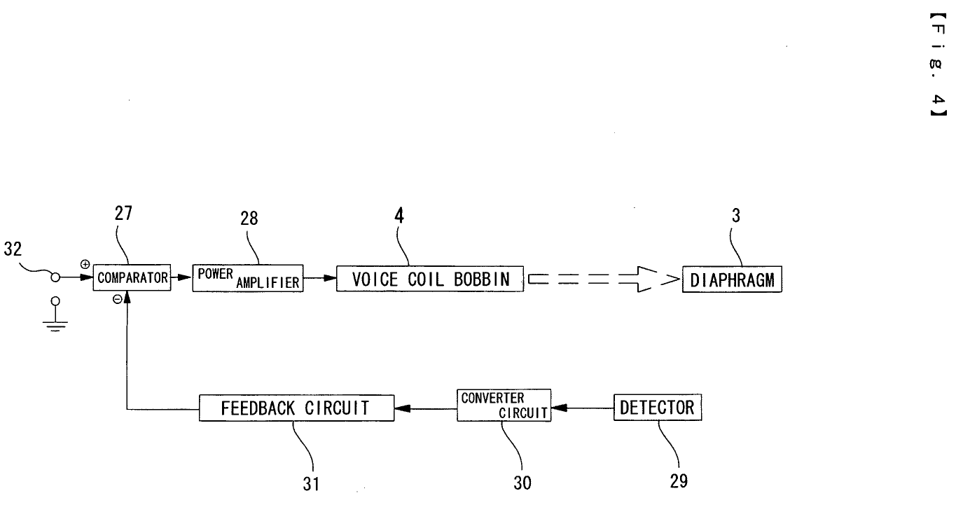

According to the structure as described above, when an audio signal is inputted into the coil 14 through a lead wire (not shown) from an input terminal 32 (see FIG. 4), the diaphragm 3 vibrates in a forward and backward direction (direction of the arrow “A” in FIG. 1) by an exciting operation through the voice coil bobbin 4, the center pole 5 and the magnet 6 to emit a sound or the like corresponding to an audio signal.

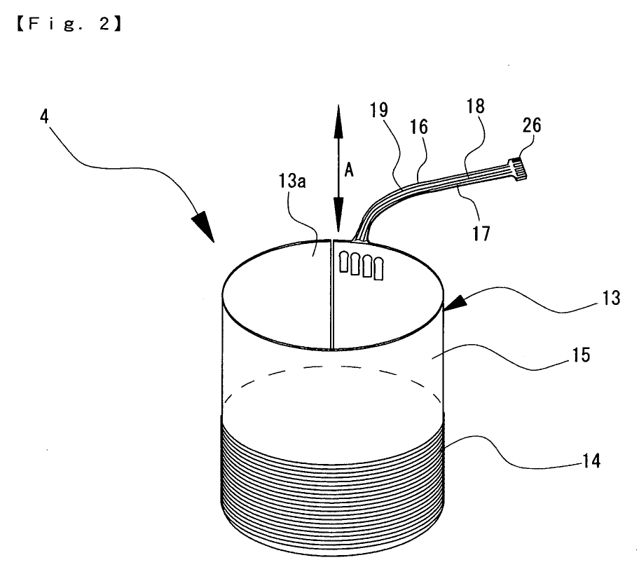

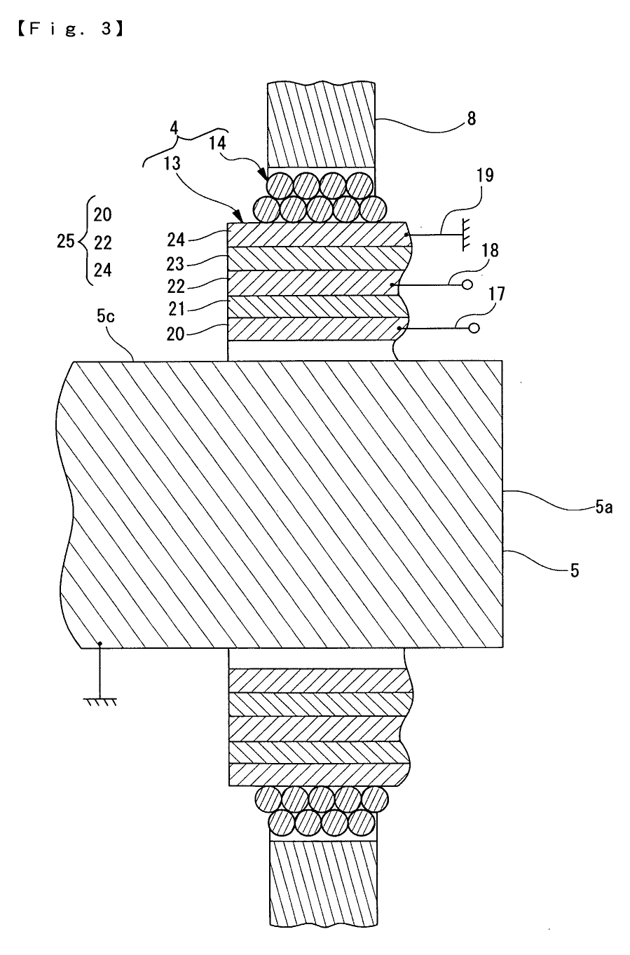

As shown in FIG. 2, the pipe body 13 is structured with a flexible board 15. A strip-shaped electric line drawing-out part 16 is integrally formed with the pipe body 13 by using the flexible board 15 itself at an edge portion on the aperture part 13a side of the pipe body 13. The electric line drawing-out part 16 is structured with output lines 17 and 18, a grounded line 19 and a second insulator layer 23 (see FIG. 3) which is drawn out in a strip-shaped manner from an edge portion on the aperture part 13a side of the pipe body 13. In other words, the electric line drawing-out part 16 is structured by means of that the second insulator layer 23 described below is drawn out in a strip-shaped manner from an edge portion on the aperture part 13a side of the pipe body 13 and the output lines 17 and 18 and the grounded line 19 are printed on the second insulator layer 23.

As shown in FIG. 3, the pipe body 13 comprises a first electric conductor layer 20, a first insulator layer 21, a second electric conductor layer 22, a second insulator layer 23 and a third electric conductor layer 24. The electrode 25 is structured with the first through third electric conductor layers 20, 22 and 24. The electrode 25 detects an electrostatic capacity that is formed between the electrode 25 and the side circumferential face 5c of the center pole 5a. The first electric conductor layer 20, the second electric conductor layer 22 and the third electric conductor layer 24 are made of a nonmagnetic electric conductor such as copper. The first insulator layer 21 and the second insulator layer 23 are made of an insulator such as polyimide. The second insulator layer 23 is a base member of the flexible board 15 which forms the pipe body 13. The first electric conductor layer 20 and the second electric conductor layer 22 for detecting an electrostatic capacity are printed on the front face side of the second insulator layer 23 through the first insulator layer 21, and the third electric conductor layer 24 is printed on the rear face of the second insulator layer 23. In this manner, the electric conductor layers and the insulator layers are laminated from the inner side of the pipe body 13 to its outer side with the first electric conductor layer 20, the first insulator layer 21, the second electric conductor layer 22, the second insulator layer 23 and the third electric conductor layer 24 in this order. Further, since an insulator layer is formed between the coil 14 and the third electric conductor 24 although it is not shown in the drawing, the coil 14 and the third electric conductor 24 are electrically insulated.

The output lines 17 and 18 for outputting a detected electrostatic capacity to the outside of the pipe body 13 as an electrical signal are connected to the first and the second electric conductor layers 20 and 22. The output lines 17 and 18 are printed on the flexible board 15 and the electric line drawing-out part 16 that is integrally formed by using the flexible board 15. Further, the output lines 17 and 18 are formed from the first and the second electric conductor layers 20 and 22 to a connector part 26 provided at the tip end part of the electric line drawing-out part 16. Electrical signals outputted from the first and the second electric conductor layers 20 and 22 are inputted into the conversion circuit 30. Further, the grounded line 19 is connected to the third electric conductor layer 24. The grounded line 19 is printed on the flexible board 15 and is formed from the third electric conductor layer 24 to the connector part 26 at the tip end part of the electric line drawing-out part 16. The third electric conductor layer 24 is electrically connected to the frame 10 through the grounded line 19 to be grounded.

When the voice coil bobbin 4 is structured, first, the above-mentioned electric conductor layers, the insulator layers and various electric lines are printed on the second insulator layer 23 which is a base member of the flexible board 15. Next, the flexible board 15 is wound around a cylindrical jig for determining a diameter of the coil 14 and both end portions in a longitudinal direction of the flexible board 15 are fixed to each other with an adhesive. Then, heat curing processing is performed on the flexible board 15 to form a cylindrical pipe body 13. Finally, the coil 14 is wound around the outer circumferential face of the pipe body 13.

As shown in FIG. 4, the speaker 1 is provided with a comparator 27, a power amplifier 28, a conversion circuit 30 and a feedback circuit 31. An electrical signal (hereinafter, referred to as “audio signal”) conveying audio information that is inputted to an input terminal 32 is inputted into the power amplifier 28 through the comparator 27 comprising of an integrated circuit. An audio signal which is amplified by the power amplifier 28 is inputted into the voice coil bobbin 4. When an audio signal flows in the coil 14 of the voice coil bobbin 4, the voice coil bobbin 4 is vibrated in a forward and backward direction (the arrow “A” direction shown in FIGS. 1 and 2) by exciting operation. The diaphragm 3 vibrates with this vibration to emit a sound or the like from the speaker 1.

Electrical signals which are outputted from the first and the second electric conductor layers 20 and 22 for detecting an electrostatic capacity are inputted into the conversion circuit 30 to be converted into a detection signal. The detection signal is inputted into the feedback circuit 31. In the feedback circuit 31, the comparator 27 and the power amplifier 28, the following feedback control is performed on the basis of the detection signal inputted from the conversion circuit 30. The feedback circuit 31 performs a prescribed signal processing to the detection signal inputted from the conversion circuit 30 to input a feedback signal corresponding to the processing result into the comparator 27. The comparator 27 compares the feedback signal with a predetermined reference value in response to the feedback signal inputted from the feedback circuit 31 to calculate the difference between the feedback signal and the predetermined reference value. A correction signal for correcting an audio signal is inputted into the power amplifier 28 on the basis of the calculated result. The power amplifier 28 corrects an output level of the audio signal on the basis of the correction signal inputted from the comparator 27 to input the corrected audio signal into the voice coil bobbin 4. In this embodiment, the feedback circuit 31 comprises an integration circuit, a buffer amplifier, an electronic volume, an adding circuit and the like (not shown).

As described above, according to the speaker 1 in accordance with an embodiment of the present invention, since the pipe body 13 is formed with the flexible board 15 in which the electrode 25 for detecting an electrostatic capacity is printed, the weight of the pipe body 13 is reduced and thus the voice coil bobbin 4 can be smoothly vibrated in a forward and backward direction (the arrow “A” direction). Further, since the electric line drawing-out part 16 is integrally formed with the pipe body 13 by using the flexible board 15, a load at the time of the voice coil bobbin 4 being vibrated in the forward and backward direction is considerably reduced by flexibility of the flexible board 15. In addition, since the electrode 25 for detecting an electrostatic capacity, the output lines 17 and 18, the grounded line 19 are formed on the flexible board 15, works such as conventionally sticking an electric conductor film which serves as an electrode for detecting an electrostatic capacity on the pipe body or soldering electric lines such as output lines or a grounded line to electrodes are not required and thus production cost of the voice coil bobbin 4 can be much reduced. In addition, when the pipe body 13 is structured by using the electric conductor layers and the insulator layers which are laminated as described in this embodiment, rigidity enough to endure vibration can be applied to the pipe body 13.

The present invention has been described in detail using the embodiments, but the present invention is not limited to the embodiments described above and many modifications can be made without departing from the present invention. For example, the pipe body 13 is structured with the flexible board 15 in which the electrode 25 for detecting an electrostatic capacity is formed, and the output lines 17 and 18 and the grounded line 19 are structured with lead wires as before and these wires may be soldered to the electrode 25.

In the embodiment described above, the electrode 25 for detecting an electrostatic capacity is comprised of the first through the third electric conductor layers 20, 22 and 24. However, only one electric conductor layer is formed on the second insulator layer 23 that is a base member of the flexible board 15, and the electric conductor layer may be used as an electrode to detect an electrostatic capacity.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A speaker comprising:
a center pole;
a voice coil bobbin which comprises a pipe body; and
at least one or more electrodes which are disposed on the pipe body to detect an electrostatic capacity formed between the electrode and a side circumferential face of the center pole;
wherein the pipe body is comprised of a flexible board on which the electrode is formed.

2. The speaker according to claim 1, further comprising an output line which is formed on the flexible board for outputting an electrical signal corresponding to the electrostatic capacity detected with the electrode to an outer side of the pipe body.

3. The speaker according to claim 1, wherein the electrodes comprises a plurality of electrodes and a grounded line which is connected to an outer most electrode of the plurality of the electrodes formed on the flexible board of the pipe body.

4. A speaker comprising:
a center pole;
a voice coil bobbin which comprises a pipe body and is disposed to vibrate in a forward and a backward directions of the center pole; and
a movable electrode which is disposed on the pipe body for detecting an electrostatic capacity that is formed between the movable electrode and a side circumferential face of the center pole;
wherein the pipe body is comprised of a flexible board which is structured of a film as a base member on which the movable electrode is printed.

5. The speaker according to claim 4, further comprising another electrode which is disposed on the pipe body,
wherein the flexible board comprises a strip-shaped electric line drawing-out part which is formed with the film being extended from an edge portion of the pipe body, and the electric line drawing-out part is structured of the film on which an output line connected to the movable electrode and a grounded line connected to the another electrode are printed.
